(19) United States
(12) Patent Application Publication
(10) Pub. No.: US 2022/0224684 A1
(43) Pub. Date: Jul. 14, 2022

(54) VALIDATING SESSION TOKENS USING NETWORK PROPERTIES

(71) Applicant: Citrix Systems, Inc., Fort Lauderdale, FL (US)

(72) Inventors: Adam Schultz, Raleigh, NC (US); Snigdhendu Mukhopadhyay, Santa Clara, CA (US); Ioannis Beredimas, Patras (GR)

(73) Assignee: Citrix Systems, Inc., Fort Lauderdale, FL (US)

(21) Appl. No.: 17/183,882

(22) Filed: Feb. 24, 2021

Related U.S. Application Data
(63) Continuation of application No. PCT/GR2021/000002, filed on Jan. 8, 2021.

(51) Int. Cl. H04L 29/06; H04L 29/08; H04L 12/707

(52) U.S. Cl. CPC H04L 63/0853; H04L 67/146; H04L 63/166; H04L 45/24; H04L 69/326

(57) ABSTRACT

Described embodiments provide systems and methods for validating session tokens using network properties. A first device having one or more processors coupled with memory may identify a session token from an initiation of a session between the first device and a second device via a network path of a plurality of network paths. The first device may determine that the first network path is to be trusted based at least on a property of the network path. The first device may validate the session token for use over the plurality of network paths, responsive to determining that the network path is to be trusted. The first device may provide, responsive to validating, the session token to the second device for use in communications over the plurality of network paths.

### CROSS-REFERENCE TO RELATED APPLICATION

This application is a continuation of and claims priority to and the benefit of International Patent Application No. PCT/GR2021/000002, titled “VALIDATING SESSION TOKENS USING NETWORK PROPERTIES,” and filed on Jan. 8, 2021, the contents of all of which are hereby incorporated herein by reference in its entirety for all purposes.

### FIELD OF THE DISCLOSURE

The present application generally relates to network sessions. In particular, the present application relates to systems and methods of validating session tokens using network properties.

### BACKGROUND

A device may establish a session with another device for communications over a network. Depending on the level of security, the session may be vulnerable to external entities intending to obtain the data communicated over the session.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

Cryptographic protocols may be used to protect communications among devices in network. Many of these cryptographic protocols (e.g., Internet Key Exchange (IKE) and Transport Layer Security (TLS)) may provide very strong identity protection that guarantee entities that are in communication with one another are what they purport to be. These protocols, however, may have very little protections to guarantee where the entity is and may be unable to provide assurances for multipath environments. For certain applications (e.g., financial transactions), it may be imperative that the network not only be secured with a trusted identity, but also that the network be accessed from trusted locations. This may be particularly the case in a multi-path environment where some connections have no inherent security or providing security that is prohibitively expensive.

In addition, sessions and tunnels for communications may be quickly re-established using tokens without user intervention in accordance with various protocols, such as the Multipath-TCP (RFC6824) under which a network identifier may be used to associate multiple paths to a single connection. While such protocols may provide for assurances in multiple paths, these communication protocols by themselves may be unable to provide protections as to where the connecting entity is.

To address these and other technical challenges, the secured token may be leveraged in a multipath network environment to allow known, secured paths to automatically permit other unknown paths to establish connections and forward network traffic. For a session or tunnel between two endpoints in a multipath environment, specific paths between the endpoints may be marked as critical or trusted. In such an environment, each path may be secured with a different session or tunnel, such as IKE or TLS. These paths may be selected when the configuration of the network in which the path traverses provides assurances for the location of the device. Examples of such configurations may include: an 1VIPLS network specifying physical access to enter the network; a node configured with a static address in a network with static routing such that traffic from a spoofed IP cannot be returned to an attacker; and a node configured with a static address in a network with reverse path filtering such that traffic from a spoofed IP cannot be returned to an attacker. While these examples are not perfectly inviolable, the network level protection provided may be sufficient to provide assurances for many applications.

During session initialization, each endpoint may generate a session token (e.g., using a cryptographic algorithm) to uniquely identify the multipath session. The session may be kept in volatile memory and may not be exposed outside of encrypted channels. In conjunction with the encrypted phase of the session negotiation, a vendor specific payload may be sent containing the multipath session token. To ensure the safety of the token, the vendor specific payload may be also be secured with the identity protection mechanism, such as public key infrastructure (PKI) signing.

When a session is successfully negotiated and a token has been received, a determination as to whether the path is to be trusted may be performed. If the path is considered trusted, the token may be marked as trusted. On the other hand, if the path is not trusted, a previously known token marked as trusted may be found. If the previous token was validated and other paths with the token are still active, the new session may be rejected or terminated. If no token has been trusted or no other session exists for other paths, no action may be taken. All endpoints may refuse to forward traffic on or process forwarded traffic from a path whose token is not trusted.

Aspects of the present disclosure are directed to systems, methods, and non-transitory computer-readable media for validating session tokens using network properties. A first device having one or more processors coupled with memory may identify a session token from an initiation of a session between the first device and a second device via a network path of a plurality of network paths. The first device may determine that the first network path is to be trusted based at least on a property of the network path. The first device may validate the session token for use over the plurality of network paths, responsive to determining that the network path is to be trusted. The first device may provide, responsive to validating, the session token to the second device for use in communications over the plurality of network paths.

In some embodiments, the first device may determine that a second network path of the plurality of network paths is not to be trusted based at least on a property of the second network path. In some embodiments, the first device may restrict a second session token of a second session for use over the plurality of network paths, responsive to determining that the second network path is not to be trusted.

In some embodiments, the first device may identify, responsive to determining that a second network path of the plurality of network paths is not to be trusted, the session token validated for use over the plurality of network paths. In some embodiments, the first device may restrict a second session token of the second network path for use over the plurality of network paths, responsive to identifying the session token.

In some embodiments, the first device may determine, responsive to determining that a second network path of the plurality of network paths is not to be trusted, that the plurality of network paths for which the session token is validated is inactive. In some embodiments, the first device may restrict, responsive to determining that the plurality of network paths is inactive, a second session over the second network path for communications between the first device and the second device.

In some embodiments, the first device may identify, subsequent to validating the session token, the session token from an initiation of a second session between the first device and the second device via a second network path of the plurality of network paths. In some embodiments, the first device may re-validate, without determination of whether the second network path is to be trusted, the session token for use in communications over the second network path

In some embodiments, the first device may validate a second session token identified from an initiation of a second session between the first device and a third device via a second network path based at least on a property of the second network path. In some embodiments, the first device may provide, responsive to validating the second session token, the second session token to the first device and the third device for use in communications over a third network path between the second device and the third device.

In some embodiments, the first device may determine that a second network path between the first device and a third device is not to be trusted based at least on a property of the second network path. In some embodiments, the first device may restrict, responsive to determining that the second network path is not to be trusted, a second session token associated with a second session over the second network path from use in communications over a third network path between the second device and the third device.

In some embodiments, the first device may cause, responsive to determining that a second network path between the first device and a third device is not to be trusted based on a property of the second network path, the third device to provide a second session token via a third network path between the second device and the third device. In some embodiments, the first device may provide, responsive to determining that the third network path is to be trusted based at least on a property of the third network path, the second session token over the third network path to the third device for use in communications over the second network path and the third network path.

In some embodiments, the first device may identify a network type of the network path as one of a plurality of trusted network types. In some embodiments, the first device may determine that the second device is configured with a static address in the network path with at least one of a static routing or a reverse path filtering. In some embodiments, the first device may provide the session token to the second device to cause the second device to store the session token to use in communications over the plurality of network paths.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIGS. 5A-D are block diagrams of an embodiment of a system for validating session tokens using network properties in accordance with an illustrative embodiment;

FIG. 6 is a communication diagram of an embodiment of a process for validating session tokens using network properties in accordance with an illustrative embodiment; and

FIG. 7 is a flow diagram of an embodiment of a method for validating session tokens using network properties in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for virtualizing an application delivery controller;

Section D describes embodiments of systems and methods for providing a clustered appliance architecture environment; and

Section E describes embodiments of systems and methods for validating session tokens using network properties.

### A. Network and Computing Environment

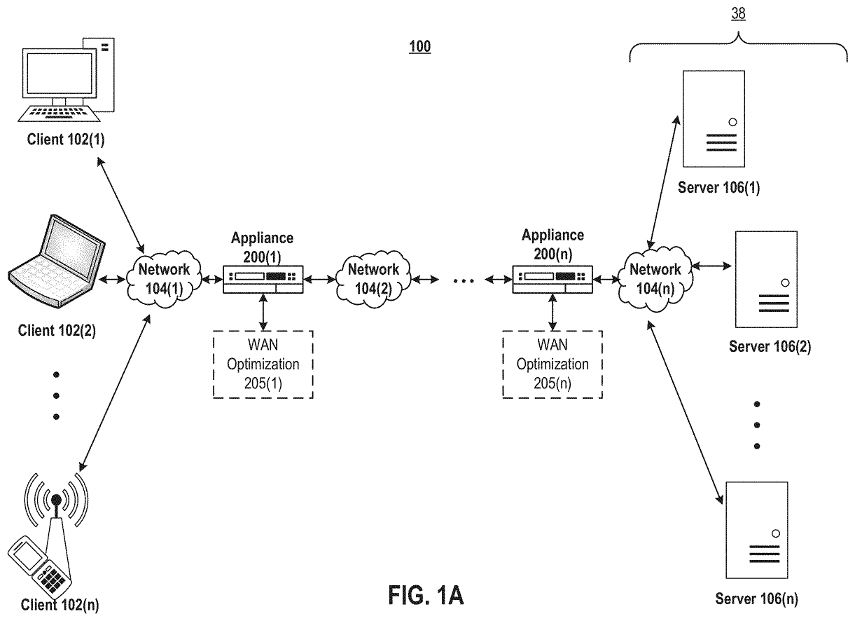

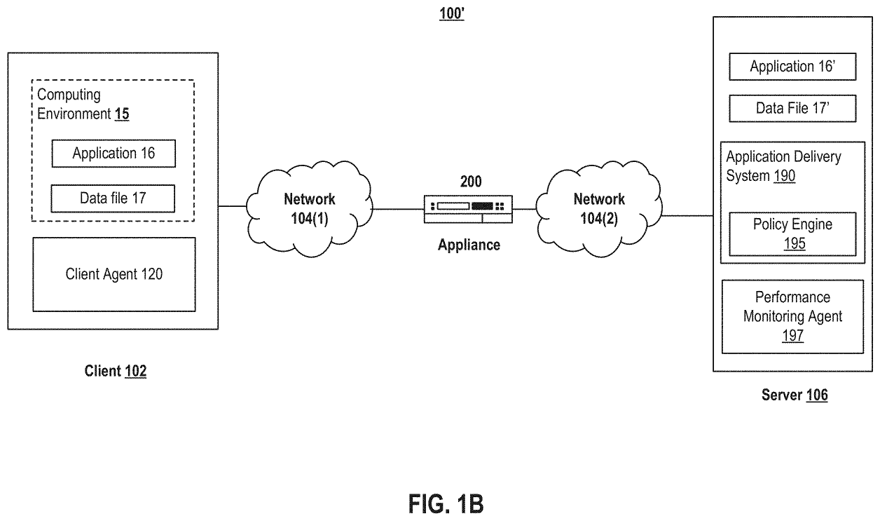

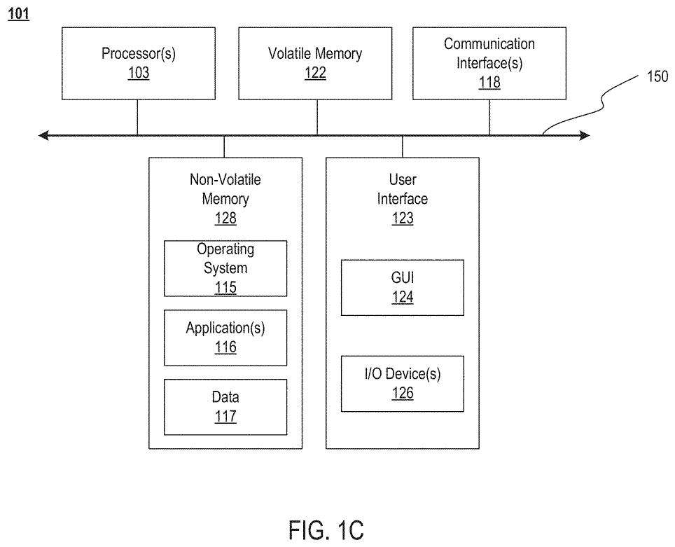

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as NetScaler® products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as CloudBridge® products sold by Citrix Systems, Inc. of Fort Lauderdale, Fla.

Referring to FIG. 1B, an example network environment 100′ for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered to the client 102 via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as XenApp® or XenDesktop®.

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 50 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliances 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as EdgeSight by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

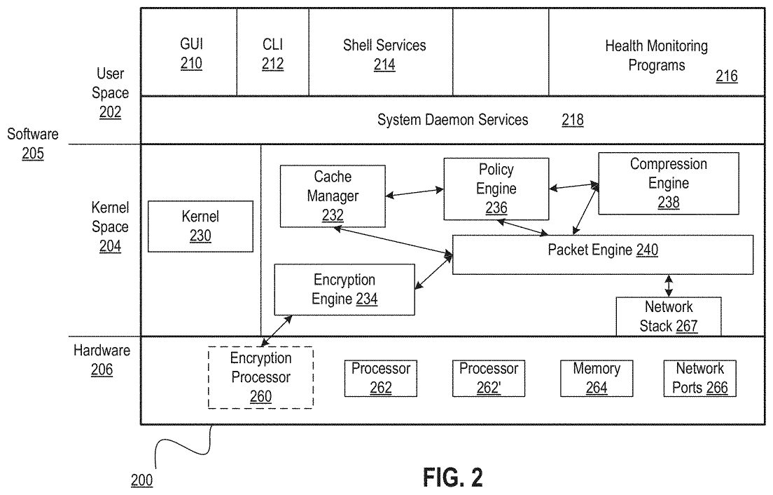

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reduce the access time of the data. In some embodiments, the cache manager 232 may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine whether a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layers connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

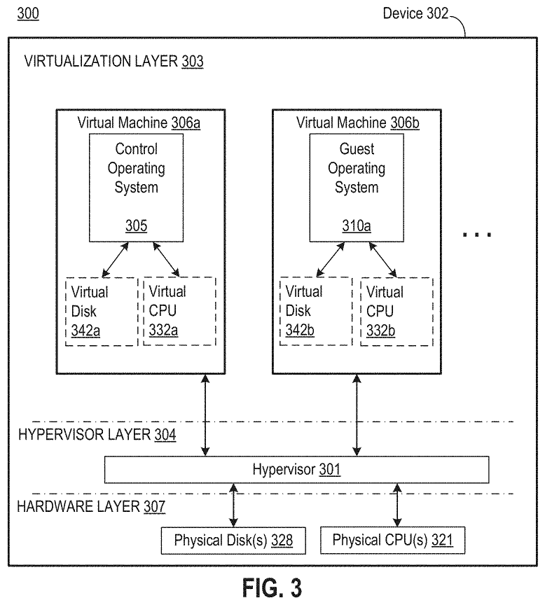

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a XEN hypervisor, for example as provided by the open source Xen.org community. In an illustrative embodiment, device 302 executing a hypervisor that creates a virtual machine platform on which guest operating systems may execute is referred to as a host server. In such an embodiment, device 302 may be implemented as a XEN server as provided by Citrix Systems, Inc., of Fort Lauderdale, Fla.

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

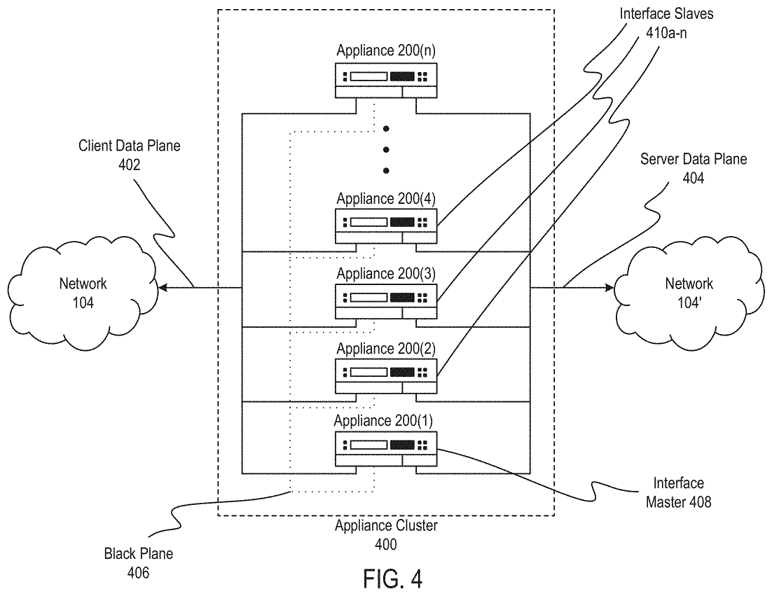

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a client-side network 104via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104′ via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Validating Session Tokens Using Network Properties

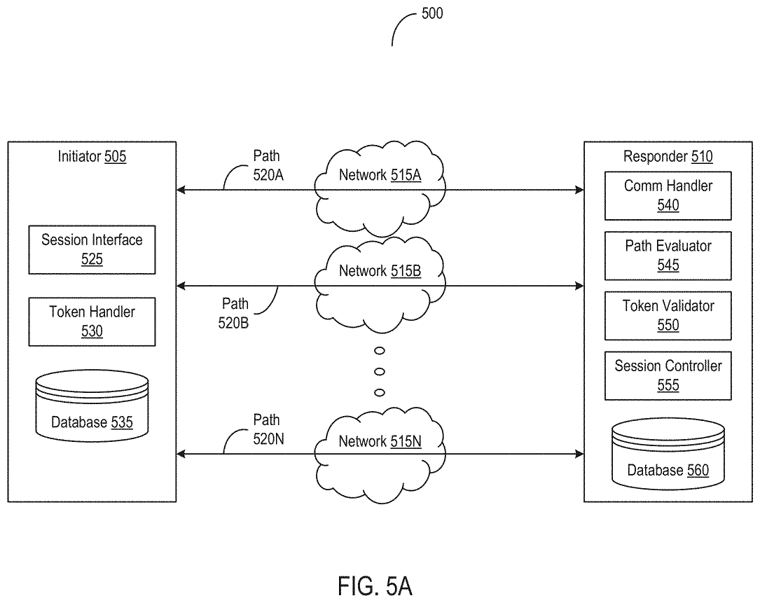

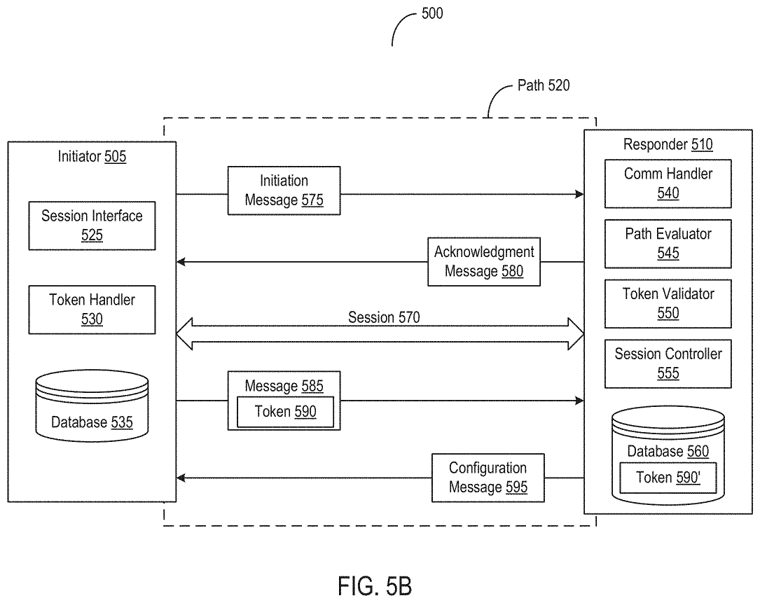

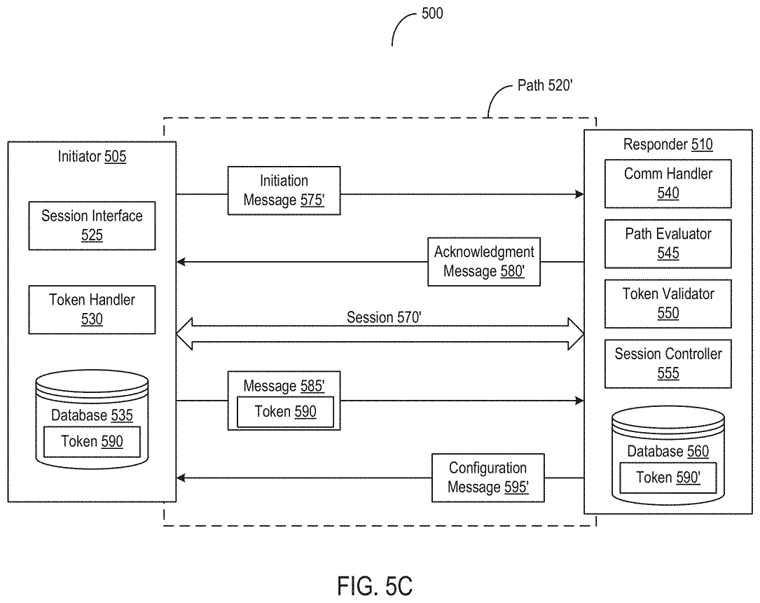

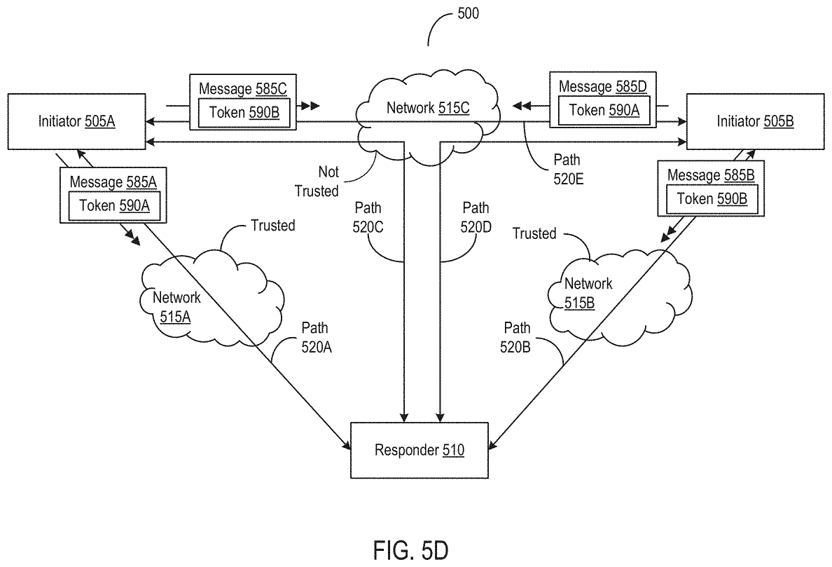

Referring now to FIG. 5A, depicted is a system 500 for validating session tokens using network properties. In overview, the system 500 may include at least one initiator 505 and at least one responder 510. The initiator 505 and the responder 510 communicatively coupled with one another over one or more networks 515A-N (hereinafter generally referred to as networks 515) via one or more paths 520 (hereinafter generally referred to as paths 520). The initiator 505 (also referred herein generally as a device) may include at least one session interface 525, at least one token handler 530, and at least one database 535. The responder 510 may include at least one communication handler 540, at least one path evaluator 545, at least one token validator 550, at least one session controller 555, and at least one database 560.

The systems and methods of the present solution may be implemented in any type and form of device, including clients 102, servers 106, and/or appliances 200. As referenced herein, a “server” may sometimes refer to any device in a client-server relationship, e.g., an appliance 200 in a handshake with a client device 102. The clients 102, servers 106, and the appliances 200 may execute any functionalities of the initiator 505 or the responder 510. In some embodiments, the initiator 505 may correspond to the client 102 and the responder 510 may correspond to the server 106 or a server-side appliance 200. In some embodiments, the initiator 505 may correspond to a client-side appliance 200 and the responder 510 may correspond to the server 106 or the server-side appliance 200. The present systems and methods may be implemented in any intermediary device or gateway, such as any embodiments of the appliance or devices 200 described herein. Some portion of the present systems and methods may be implemented as part of a packet processing engine and/or virtual server of an appliance, for instance. The systems and methods may be implemented in any type and form of environment, including multi-core appliances, virtualized environments and/or clustered environments described herein.

In further detail, the one or more networks 515 may communicatively couple the initiator 505 and the responder 510 with each other. The networks 515 may be established (e.g., previously by the initiator 505, the responder 510, or another entity) in accordance with any number of routing techniques or security mechanisms. The routing techniques may include, for example, static routing (e.g., a multiprotocol label switching (MPLS), default static route, default static route, summary static route, and the floating static rule) and dynamic or adaptive routing (e.g., Open Shortest Path First (OSPF) or Intermediate System to Intermediate System (IS-IS), and Interior Gateway Routing Protocol (GRP), and the Internet (INET)), among others. The security mechanisms may include, for example, reverse-path filtering (RPF), ingress filtering, or egress filtering, among others. At least one network 515 (e.g., MPLS) may specify or entail physical access by the participant nodes (e.g., the initiator 505 and the responder 510) for entry and access. Conversely, at least one other network 515 (e.g., INET) may not entail physical access by the participant nodes for entry and access. In addition, each network 515 may facilitate or support one or more paths 520 for communications between the initiator 505 and the responder 510. The communications over the path 520 may be in accordance with established and secured with any number of communications protocols to, such as Internet Key Exchange (IES), Transport Layer Security (TLS), and Transmission Control Protocol (TCP), among others.

Referring now to FIG. 5B, depicted is the system 500 for validating session tokens using network properties focused on one of the paths 520 (e.g., the path 515A) of one network 515 (e.g., the network 515A) between the initiator 505 and the responder 510. The session interface 525 executing on the initiator 505 may start or initiate at least one session 570 with responder 510 over the path 520 via the network 515. Conversely, the communication handler 540 executing on the responder 510 may manage or facilitate the initiation of the session 570 with the initiator 505 over the path 520 via the network 515. The session 570 may be used to facilitate or support communications between the initiator 505 and the responder 510 over the path 520 of the network 515. For example, an application executing on the initiator 505 may initiate the session 570 to access resources for the application hosted or accessible via the responder 510 over the network 515 via the path 520.

To initiate, the session interface 525 executing on the initiator 505 and the communication handler 540 may exchange or communicate a series of messages in accordance with a communication protocol. In some embodiments, the session interface 525 of the initiator 505 and the communication handler 540 of the responder 510 may perform the initiation of the session 570 in accordance with a handshake process of the communication protocol (e.g., TCP handshake process). The session interface 525 may send, provide, or otherwise transmit at least one initiation message 575 over the path 520 of the network 515. The initiation message 575 may include information (e.g., in the header or metadata) defining the establishment of the session 570 over the path 520 via the network 515 with the responder 510. The information may include source address (e.g., Internet Protocol (IP) address or media access control (MAC) address) and source port corresponding to the initiator 505. The information may also include destination address (e.g., IP address or MAC address) and destination port corresponding to the responder 510. The source and destination addresses may be defined in accordance with the network 515 over which the session 570 is to be established, and the type of network address (e.g., static, dynamic, public, or private IP address) may be identified in the information. For example, when the network 515 uses static routing, the source and destination addresses may be static IP addresses. On the other hand, when the network 515 uses dynamic routing, the source and destination addresses may be dynamic IP addresses. The message from the initiator 505 may identify or include session information, such as network type (including the routing technique) of the network 515 and the encryption protocol to be applied to the communications in the session 570 via the path 520, among others.

In turn, the communication handler 540 may identify, obtain, or otherwise receive the initiation message 575 from the initiator 505. With receipt of the initiation message 575, the communication handler 540 may store and maintain the session information from the initiation message 575 for the session 570 on the database 560. The session information may be stored on the database 560 with a session state that the associated session 570 is active. In addition, the communication handler 540 may generate at least one acknowledgement message 580 in accordance with the handshake process of the communication protocol. The acknowledgment message 580 may indicate the completion of the establishment of the session 570 between the initiator 505 and the responder 510. The acknowledgment message 580 may include the information identified by the initiation message 575. For example, the information of the acknowledgement message 580 may include the source address and source port corresponding to the responder 510, the destination address and port corresponding to the initiator 505, and the session information (e.g., the network type of the network 515 and the communication protocol), among others. Upon generation, the communication handler 540 may send, provide, or otherwise transmit the acknowledgement message 580 to the initiator 505. The session interface 525 in turn may receive the acknowledgement message 580 from the responder 510. The receipt of the acknowledgement message 580 may mark the completion of the establishment of the session 570 between the initiator 505 and the responder 510.

In response to the receipt of the acknowledgment message 580, the session interface 525 may generate at least one token message 585 to send to the responder 510. The token message 585 may be generated in accordance with the communications protocol for the network 515 over which the path 520. The session interface 525 may determine, create, or otherwise generate at least one token 590 to include in the token message 585. The token 590 may include a set of alphanumeric characters or a numeric value to reference or uniquely identify the session 570 between the initiator 505 and the respond 510 over the path 510 via the network 515. The token 590 may be a multi-path token and may be applicable to the one or more paths 510 overs one or more networks 515. The token 590 may be generated by the session interface 525 according to an encryption algorithm, such as a cryptographic key, digital signature, a message authentication code, or a cryptographic hashing function, among others. With the generation, the session interface 525 may add, insert, or include the token 590 in the token message 585. The token message 585 may also include the information discussed above with respect to the initiation message 575. The session interface 525 may then send, provide, or otherwise transmit to the responder 510 via the path 520 over the network 515.

In turn, the communication handler 540 may retrieve, identify, or otherwise receive the token message 585 sent by the initiator 505 in conjunction with the initiation of the session 570. Upon receipt, the communication handler 540 may parse the token message 585 to extract, retrieve, or otherwise identify the token 590 included in the token message 585. The communication handler 540 may also store and maintain the token 590 identified from the token message 585 onto the database 560. In some embodiments, the communication handler 540 may store an association of the token 590 with the session 570 or the initiator 505 onto the database 560. If there were other sessions established between the initiator 505 and the responder 510, the communication handler 540 may also store and maintain one or more previous tokens 590′ from such sessions on the database 560. The communication handler 540 may store and maintain the association of the token 590′ with the prior session or the initiator 505 on the database 560. The token 590′ may also be stored on the database 560 with an indication of whether the token 590′ is validated or not validated. The validation of the tokens 590 and 590′ is detailed herein below.

The path evaluator 545 executing on the responder 510 may identify or otherwise determine at least one property of the network 515 (or the path 520 established over the network 515). The property of the network 515 or the path 520 may include the routing technique for directing the communications over the network 515, an access requisite to enter the network 515, a communication protocol used to secure the communications over the network 515, and a configuration of the initiator 505 with respect to the network 515. The routing technique may include static routing or dynamic routing as discussed above. The access requisite may identify one or more conditions for the initiator 505 to enter the network 515. The communication protocol may include protocols used to secure communications over the network 515 as discussed above. The configuration may include a type of the source address (e.g., static or dynamic IP address) corresponding to the initiator 505 and access requisites for the network 515, among others.

To identify the property of the network 515, the path evaluator 545 may parse the at least one of the messages (e.g., the initiation message 575, the acknowledgement message 580, and the token message 580) exchanged via the path 520 in establishing the session 570. In some embodiments, the path evaluator 545 may retrieve or identify the session information from the initiation message 575 to identify the property of the network 515. In some embodiments, the path evaluator 545 may parse the message to extract or identify the session information regarding the session 570 established via the path 520 over the network 515. From parsing, the path evaluator 545 may identify the routing technique used by the path 520 over the network 515 as one of the properties of the network 515. In some embodiments, the path evaluator 545 may identify a property of a point of access used to establish the session 570 to identify the property of the network 515. The point of access may be a network node (e.g., a router or a gateway) or a network interface of a device (e.g., the communication interface 118). The property of the point of access may include, for example, the access requisite, the routing technique, or security mechanism. To identify the point of access, the path evaluator 545 may access the point of access associated with the session 570. In some embodiments, the path evaluator 545 may determine the access requisite for the network 515 (e.g., physical or logical access based on the routing technique, and may use the access requisite as one of the properties for the network 515. The path evaluator 545 may also identify the encryption protocol to be applied to the communications in the session 570 over the path 520 as another property of the network 515. The path evaluator 545 may further identify the type of address for the network address referencing the initiator 505 (or the responder 510) as another property associated with the network 515.

Based on the one or more properties of the network 515 (or the path 520), the path evaluator 545 may determine whether the network 515 (or the path 520 established over the network 515) is to be trusted. In determining, the path evaluator 545 may compare the properties of the network 515 with a rule set (also referred herein as a policy, requisites, or conditions) for trusted networks. The rule set may be predefined or pre-configured by a network administrator of the responder 510, and may define, identify, or otherwise specify a combination of properties (e.g., routing technique, access requisite, encryption protocol, type of address) for the network 515 to be trusted. One combination of properties identified by the rule set may specify that the network 515 over which the session 570 is established be a MPLS network and the access requisite for the network 515 is physical access. Another combination of properties may define that the network address for the initiator 505 is a static address and that the routing technique employed by the network 515 is static routing. Another combination of properties defined by the rule set may identify that the initiator 505 is a static address and that the routing technique employed is reverse-path filtering.

When the properties identified for the network 515 (or the path 520) do not match with any combination of properties identified by the rule set for trusted networks, the path evaluator 505 may determine that the network 515 (or the path 520) is not to be trusted. The path evaluator 505 may also store and maintain an indication of the network 515 as untrusted onto the database 560. In some embodiments, the path evaluator 505 may store an association of the network 505 as untrusted with the session information for the session 570 onto the database 560. In some embodiments, the path evaluator 505 may store an association of the path 520 established over the network 515 as untrusted with the session information for the session 570 onto the database 560. Otherwise, when the properties identified for the network 515 (or the path 520) match with at least one combination of properties laid out in the rule set for trusted networks, the path evaluator 505 may determine that the network 515 (or the path 520) is to be trusted. The path evaluator 505 may also store and maintain an indication of the network 515 as trusted on the database 560. In some embodiments, the path evaluator 505 may store an association of the network 515 as trusted with the session information for the session 570. In some embodiments, the path evaluator 505 may store an association of the path 520 established over the network 515 as trusted with the session information for the session 570.

Depending on the determination as to whether the network 515 is determined to be trusted, the token validator 550 executing on the responder 510 may validate the token 590 from use in communications over one or more of the networks 515 (and paths 520) between the initiator 505 and the responder 510. When the network 515 is determined to be trusted, the token validator 550 may validate the token 590 for use in communications over one or more networks 515 between the initiator 505 and the responder 510. The token validator 550 may also store and maintain an indication of the token 590 as validated on the database 560. Conversely, when the network 515 is determined to be not trusted, the token validator 550 may not validate or otherwise restrict the token 590 from use in the communications over one or more of the networks 515 except for the current session 570. Further restrictions of the token 590 and the associated session 570 may be based on other factors and conditions.

In some embodiments, when the network 515 is determined to be not trusted, the token validator 550 may determine whether a previous token 590′ for the initiator 505 exists. The previous token 590′ may be from a previous session established between the initiator 505 and the responder 510 over any one of the networks 515. In determining, the token validator 550 may access the database 560 to search or find the token 590′ associated with the initiator 505. If no token 590′ associated with the initiator 505 is found, the token validator 550 may determine that no previous token 590′ for the initiator 505 exists. In addition, the token validator 550 may not validate or otherwise restrict the token 590 for use in communications over one or more of the networks 515. The restriction of the token 590 may include the current session 570 and the path 520 over the network 515. The token validator 550 may also store and maintain an indication of the 590 as not validated onto the database 560.

On the other hand, if at least one token 590′ associated with the initiator 505 is found, the token validator 550 may determine whether the previous token 590′ was validated. As discussed above, the token 590′ may have been stored and maintained on the database 560 with an indication as to whether the previous token 590′ was validated. In determining, the token validator 550 may access the database 560 to identify the indication of validation for the previous token 590′ associated with the initiator 505. If the indication identifies the previous token 590′ as not validated, the token validator 550 may not validate or otherwise restrict the token 590 for communications over one or more of the networks 515, except for the current session 570. The token 590 may be used for the current session 570 over the path 520 via the network 515, but not for other communications over other networks 515 between the initiator 505 and the responder 510. The token validator 550 may also store and maintain an indication of the token 590 as not validated onto the database 560. In some embodiments, the token validator 550 may perform no further action upon determining that none of the session states are indicated as active.

In contrast, if the indication identifies the previous token 590′ as validated, the token validator 550 may determine whether other sessions or paths 520 between the initiator 505 and the responder 510 are active or inactive. To determine, the token validator 550 may access the database 560 to identify a session state for each of the other sessions established between the initiator 505 and the responder 510. The session state may identify whether the other session is active or inactive. The identified session state may at least include that of the session associated with the previous token 590′. If any of the session states of the other session is indicated as active, the token validator 550 may permit or allow the current session 570 for communications. In addition, the token validator 550 may validate or permit the token 590 for use in communications in the current session 570. In some embodiments, the validation of the token 590 may be limited to the current session 570 over the path 520, but not for other communications over the other networks 515. In some embodiments, the token validator 550 may carry out no further action in response to the determination to allow the current session 570. On the other hand, if none of the session states of the other session is indicated as active, the token validator 550 may not validate or otherwise restrict the token 590 for communications over one or more of the networks 515, including the current session 570. In some embodiments, the token validator 550 may re-initiate negotiation of the token 590 in the manner described above.

The session controller 555 executing on the responder 510 may manage or handle the session 570 based on the determination as to whether the token 590 from the session 570 is validated or not validated. The handling of the session 570 may also be dependent on the restrictions determined based on the previous token 590′ and other sessions as discussed above. When the token 590 is validated, the session controller 555 may send, provide, or otherwise transmit the token 590 via at least one configuration message 595. The configuration message 595 may include the token 590 and the indication that the token 590 is validated for communications across one or more of the networks 515 between the initiator 505 and the responder 510. In some embodiments, the session controller 555 may generate the configuration message 595 to include the token 590 and at least a portion of the information discussed above included in the previous messages. By providing the configuration message 595, the session controller 555 may indicate to the initiator 505 that the token 590 is permitted to be used for communications over one or more of the networks 515 between the initiator 505 and the responder 510.

On the other hand, when the token 590 is not validated, the session controller 555 may generate the configuration message 595 to send, provide, or otherwise transmit to the initiator 505 according to the determination of restrictions for the token 590. If the token 590 is not validated for communications including for the current session 570, the session controller 555 may restrict the session 570 over the path 520 of the network 515. In some embodiments, the session controller 555 may terminate or cease the establishment of the session 570 over the path 520 via the network 515. The session controller 555 may include the token 590 and an indication to restrict (e.g., terminate) the session 570 associated with the token 590 in the configuration message 595. In some embodiments, the indication may also identify that the token 590 is not to be used over any communications over any of the networks 515 with the responder 510. With the inclusion, the session controller 555 may transmit the configuration message 595 to the initiator 505 via the path 520 over the network 515. Conversely, if the token 590 is not validated for communications excluding the current session 570, the session controller 555 may generate the configuration message 595 to include the token 590 and an indication that the token 590 is validated for communications limited to the network 515. The indication may also identify that the token 590 is not validated for communications over other networks 515 between the initiator 505 and the responder 510. Upon inclusion, the session controller 555 may transmit the configuration message 595 to the initiator 505 via the path 520 over the network 515.

From the responder 510, the token handler 530 executing on the initiator 505 may identify or receive the configuration message 595. Upon receipt, the token handler 530 may parse the configuration message 595 to extract or identify the token 590 and the indication. Based on the indication, the token handler 530 may manage or configure the session 570 established over the path 520 via the network 515. When the indication is that the token 590 is to restrict the session 570, the token handler 530 may terminate or cease the session 570 associated with the token 590 and communications with the responder 510 over the session 570. In some embodiments, the token handler 530 may also terminate or cease the session 570, when the indication from the configuration message 595 is that the token 590 is not validated for any communications between the initiator 505 and the responder 510.

In addition, when the indication is that the token 590 is validated for use in communications limited to the network 515, the token handler 530 may use the token 590 for subsequent communications with the responder 510 within the current session 570. The token handler 530 may allow or permit continued communications from the initiator 505 to the responder 510 over the current session 570 via the network 515. The token handler 530 may store and maintain the token 590 on the database 535 for communications over the network 515 over which the session 570 is established. With the indication, the token handler 530 may refrain from using the token 590 in communications over other networks 515 with the responder 510. The token 590 may be used for the duration of the session 570 via the path 520 over the network 515, but may not be used in communications for other networks 515. Otherwise, when the indication is that the token 590 is validated for use in communications over one or more of the networks 515, the token handler 530 may use the token 590 for subsequent communications with the responder 510. The token handler 530 may also allow or permit continued communications from the initiator 505 to the responder 510. Furthermore, the token handler 530 may store and maintain the token 590 on the database 535 for communications over one or more other networks 515 with the responder 510.

Referring now to FIG. 5C, depicted is the system 500 for revalidating session tokens focused on one of the paths 520′ (e.g., the path 515B) of one network 515 (e.g., the network 515B) between the initiator 505 and the responder 510. Subsequently, with the indication that the token 590 is validated for use in communications over other networks 520, the session interface 525 may initiate another session 570′ over another path 520′ via another network 515 using the token 590. The network 515 over which the subsequent session 570′ may have properties that would be determined to be not trusted under the rule set applied by the path evaluator 545. Nonetheless, as the token 590 may have been previously validated over the other network 515 with properties determined to be trusted, the session interface 525 may use the token 590 to establish the subsequent session 570′ over the network 515. The initiation of the subsequent session may be performed in a similar manner as discussed above. For example, the session interface 525 may transmit an initiation message 575′ containing information for establishment of the new session 570′. In return, the communication handler 540 may respond with an acknowledgment message 580′ to the initiator 505 to complete the establishment of the session 570′ between the initiator 505 and the responder 510 via the path 520 of the network 515. With the establishment of the session 570′, the session interface 525 may access the database 530 to retrieve or identify the token 590 previously validated at the responder 510. Once identified, the session interface 525 may generate a token message 585′ to include the token 590′ from the database 535. The session interface 525 may send, transmit, or otherwise provide the token message 585′ including the token 590′ to the initiator 505.

In turn, the communication handler 540 may identify or receive the token message 585′ sent by the initiator 505. Upon receipt, the communication handler 540 of the responder 510 may parse the token message 585′ to extract or identify the token 590. The token validator 550 may determine whether the token 590 identified from the token message 585 was previously validated. To determine, the token validator 550 may search or find the database 560 using the token 590 identified from the token message 585′. As the token 590 was previously validated, the token validator 550 may find the token 590′ stored and maintained on the database 560 that matches token 590. When found, the token validator 550 may determine that the token 590 has been previous validated. In some embodiments, based on the finding of the match, the token validator 550 may revalidate the token 590 without determination as to whether the network 515 to which the path 520′ belongs is to be trusted. In response to the determination that the token 590 was previously validated, the session controller 595 may transmit the token 590 via at least one configuration message 595′ to the initiator 505. The configuration message 595′ may also include the indication that the token 590 is re-validated for communications across one or more of the networks 515 between the initiator 505 and the responder 510.

From the responder 510, the token handler 530 of the initiator 505 may identify or receive the configuration message 595′. Upon receipt, the token handler 530 may parse the configuration message 595 to extract or identify the token 590 and the indication. Based on the indication that token 590 is re-validated for use in communications over one or more of the networks 515, the token handler 530 may use the token 590 for subsequent communications with the responder 510 in the new session 570′. The token handler 530 may also allow or permit continued communications from the initiator 505 to the responder 510.

Referring now to FIG. 5D, depicted is a block diagram of the system 500 for validating session tokens from various initiators 505 (e.g., initiators 505A and 505B) over multiple networks (e.g., networks 515A-C) and multiple paths (e.g., paths 520A-E). The functionalities of the initiators 505A and 505B and the responder 510 may be similar to those detailed herein above. The validation of tokens 590 over a network 515 (e.g., the networks 515A and 515B as depicted) that is determined to be trusted may be used to establish a session 570 over a network 515 (e.g., the network 515C as depicted) that would be determined as not trusted. The initiations of the session 570 between the initiator 505A and the responder 510 over the network 515A and the session 570 between the initiator 505B and the responder 510 over the network 515B may be performed as discussed above. With the initiation, the session interface 525 of the initiator 505A may transmit a token message 585A including a token 590A to the responder 510. The token 590A may identify the session established over the network 515A. Likewise, the session interface 525 of the initiator 505B may transmit a token message 585B including a token 590B to the responder 510.

With the receipt of the token messages 585A and 585B, the communication handler 540 of the responder 510 may parse the token message 585A to identify the token 590A and parse the token message 585B to identify the token 590B. The path evaluator 545 of the responder 510 may determine whether the network 515A associated with the token 590A is to be trusted based on a property of the network 515A. Similarly, the path evaluator 545 of the responder 510 may determine whether the network 515B associated with the token 590B is to be trusted based on a property of the network 515B.

When one of the networks 515 (e.g., the network 515B contrary to the depiction) is determined to be not trusted, the session controller 555 of the responder 510 may not validate the token 590 (e.g., the token 590B) associated with the network 515. The session controller 555 may also restrict the session 570 over the network 515 in the manner as discussed above. The session controller 555 may provide a configuration message 595 to the initiator 505B with an indicator that the token 590 is not validated for communications. In contrast, the other network 515 (e.g., the network 515A) may be determined to be trusted based on the property of the network 515A. For example, the network 515A may be a MPLS network that would have properties determined to be trusted, whereas the network 515B may be a public Internet network that would have properties determined to be not trusted. Based on these determinations, the session controller 555 may transmit a configuration message 595 including an indicator to the initiator 505A in communication over the other network 515A that the token 590B is not validated. The configuration message 595 may include the token 590A with an indication that the token 590A has been validated for communications with the responder 510. For example, the initiator 505A may use the token 950A for communications over the path 520A via the network 515A and over the path 520C via the network 515C. With the receipt of the configuration message 595, the initiator 505A may continue communications with the responder 510 over the network 515A.

Conversely, when both the networks 515A and 515B are determined to be trusted (e.g., as depicted), the token validator 550 of the responder 510 may validate the tokens 590A and 590B. For example, the network 515A and 515B may be both MPLS networks. Based on the validation, the session controller 555 of the responder 510 may transmit a configuration message 595 to the initiator 505A including an indicator that the token 590A is validated for communications among the initiators 505A and 505B and the responder 510. The communications may include, for example, those over the path 520A-E over networks 515A-C. In some embodiments, the session controller 555 may also provide the token 590B from the initiator 505B to the initiator 505A via the configuration message 595. Furthermore, the session controller 555 may transmit a configuration message 595 to the initiator 505B including an indicator that the token 590B is validated for communications among the initiators 505A and 505B and the responder 510. In some embodiments, the session controller 555 may also provide the token 590A from the initiator 505A to the initiator 505B via the configuration message 595.

Subsequently, the token handler 530 of the initiator 505A may receive the configuration message 595 from the responder 910. The token handler 530 of the initiator 505A may identify both the tokens 950A and 950B for use in communications among the initiator 505A and 505B and the responder 510. The token handler 530 may store and maintain the tokens 950A and 950B on the database 536 of the initiator 505A. Likewise, the token handler 530 of the initiator 505B may receive the configuration message 595 from the responder 910. The token handler 530 of the initiator 505B may identify both the tokens 950A and 950B for use in communications among the initiator 505A and 505B and the responder 510. The token handler 530 may store and maintain the tokens 950A and 950B on the database 536 of the initiator 505B.

To establish a session over the network 515C, each of the initiator 505A and 505B may perform a procedure as discussed above, and exchange the initiation message 575 and acknowledgement message 580 with each other over the path 520E of the network 515C. The network 515C may have one or more properties that would be determined to be untrusted by the path evaluator 545 of the responder 510. With the establishment of the session, the initiators 505A and 505B may exchange token messages 585C and 585D respectively over the network 515C. The token message 585C from the initiator 505A may include the token 590B of the initiator 505B validated by the responder 510. Conversely, the token message 585D from the initiator 505B may include the token 590A of the initiator 505A validated by the responder 510. With the receipt of the token 590A and 590B, the session interface 525 at each initiator 505A and 505B may check whether the token 590A or 590B is stored on the respective database 535 to revalidate the token 590A and 590B. When found, the session interface 525 of each initiator 505A and 505B may send a configuration message 595 to indicate the re-validation of the tokens 590A and 590B.

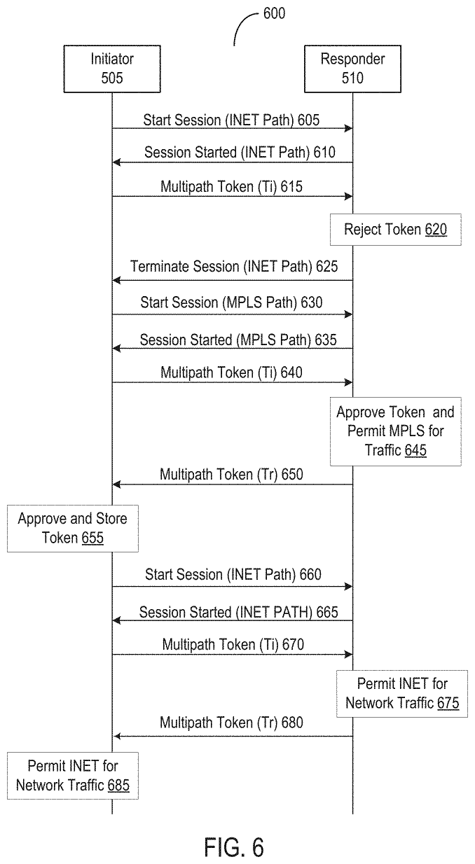

Referring now to FIG. 6, depicted is a communication diagram of a process 700 for validating session tokens using network properties. The functionalities of process 700 may be implemented using, or performed by, the components described in FIGS. 1-5, such as the initiator 505 or the responder 510. In brief overview, the initiator 505 may send a start session message via an Internet path to the responder 510 (605). The responder 510 may return a session started message via the Internet path to the initiator 505 (610). The initiator 505 may provide a multipath token to the responder 510 via the Internet path (615). As the Internet path is untrusted, the responder 510 may reject the token (620). The responder 510 may terminate the session over the Internet path (625).

The initiator 505 may send a start session message via a multiprotocol label switching (MPLS) path to the responder 510 (630). The responder 510 may return a session started message via the MPLS path to the initiator 505 (635). The initiator 505 may provide a new multipath token to the responder 510 via the MPLS path (640). As the MPLS path is trust, the responder 510 may accept the token and permit the MPLS path for network traffic (645). The responder 510 may return token as validated over the MPLS path to the initiator 505 (650). The initiator 505 may in turn approve and store the validated token (655).

Subsequently, the initiator 505 may send a start session message via an Internet path to the responder 510 (660). The responder 510 may return a session started message via the Internet path to the initiator 505 (665). The initiator 505 may provide the previously validated multipath token to the responder 510 via the Internet path (670). Since the token was previously provided over the MPLS path and was validated, the responder 510 may permit the Internet path for network traffic (675). The responder 510 may return token over the Internet path to the initiator 505 (680). The initiator 505 may permit the Internet path for network traffic (685).

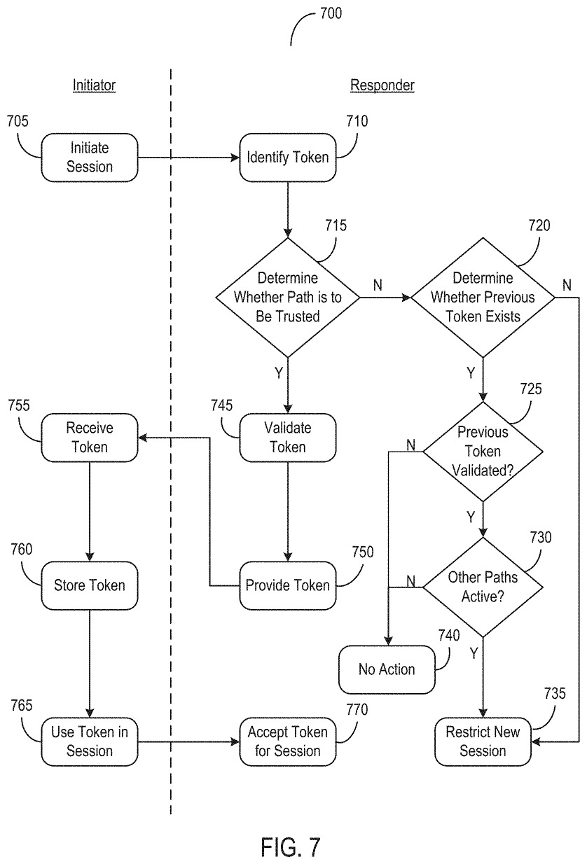

Referring now to FIG. 7, depicted is a flow diagram for a method 800 of validating session tokens using network properties. The functionalities of method 800 may be implemented using, or performed by, the components described in FIGS. 1-7, such as the initiator 505 or the responder 510. In overview, an initiator may initiate a session (705). A responder may identify a token (710). The responder may determine whether a path is to be trusted (715). If the path is not to be trusted, the responder may determine whether a previous token exists (720). If the previous token exists, the responder may determine whether the previous token was validated (725). If the previous token was validated, the responder may determine whether other paths are active (730). If no previous tokens exists or when at least one path is determined to be active, the responder may restrict the new session (735). Otherwise, if no other paths are active or no previous token was validated, the responder may take no action (740). On the other hand, if the path is to be trusted, the responder may validate the token (745). The responder may provide the token (750). The initiator may receive the token (755). The initiator may store the token (760). The initiator may use the token in a session (765). The responder may accept the token for the session (770).

In further detail, an initiator (e.g., the initiator 505) may initiate a session (e.g., the session 570) with a responder (e.g., the responder 510) (705). The initiator and the responder may exchange a set of messages (e.g., the initiation message 575 and the acknowledgement message 580) to establish the session. The session may be established over a path (e.g., the path 520) via a network (e.g., the network 515) between the initiator and the responder. The responder may identify a token (e.g., the token 590) (710). From the initiation of the session, the initiator may provide a message (e.g., the token message 585) including the token to the responder. The responder may parse the message to identify the token.

The responder may determine whether the path is to be trusted (715). The responder may identify properties of the network associated with the path. The properties of the network may include a routing technique applied, an access requisite to enter the network, a communication protocol, a configuration of the initiator or the responder, among others. The responder may compare the properties of the network with a rule set defining conditions to be a trusted network. When the properties match, the responder may determine that the path is to be trusted. Otherwise, when any of the properties do not match, the responder may determine that the path is not to be trusted.

If the path is not to be trusted, the responder may determine whether a previous token exists (720). The previous token may be from a previous session established between the initiator and the responder. The responder may access a database (e.g., the database 560) to find whether the previous token exists. If the previous token exists, the responder may determine whether the previous token was validated (725). The responder may access the database to identify an associated indicator as to whether the previous token was validated.

If the previous token was validated, the responder may determine whether other paths are active (730). The responder may access the database to identify session information each of the paths between the initiator and the responder. The session information may identify whether the path (or session) is active or inactive. When the session information indicates that the path is active, the responder may determine that the path is active. Conversely, when the session information indicates that the path is inactive, the responder may determine that the path is inactive. If no previous tokens exists or when at least one path is determined to be active, the responder may restrict the new session (73 5). Otherwise, if no other paths are active or no previous token was validated, the responder may take no action (740).

On the other hand, if the path is to be trusted, the responder may validate the token (745). The token may be validated for communications via other networks and paths between the initiator and the responder. The responder may provide the token (750). The responder may send the token using a message (e.g., the configuration message 595) to the initiator. The initiator may receive the token (755). The initiator may parse the message received from the responder to identify the token. The initiator may store the token (760). Upon identification, the initiator may store and maintain the token on a database (e.g., the database 535) for communications between the initiator and the responder. The initiator may use the token in a session (e.g., the session 570′) (765). The session may be established over another network via another path (e.g., the path 520′) The responder may accept the token for the session (770). The acceptance of the token may be performed without any determination as to whether the network is to be trusted.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

It will be further understood that various changes in the details, materials, and arrangements of the parts that have been described and illustrated herein may be made by those skilled in the art without departing from the scope of the following claims.

We claim:

1. A method of validating a session token using a property, comprising:
identifying, by a first device, a session token from an initiation of a session between the first device and a second device via a network path of a plurality of network paths;
determining, by the first device, that the first network path is to be trusted based at least on a property of the network path;
validating, by the first device, the session token for use over the plurality of network paths, responsive to determining that the network path is to be trusted; and
providing, by the first device responsive to validating, the session token to the second device for use in communications over the plurality of network paths.

2. The method of claim 1, further comprising:
determining, by the first device, that a second network path of the plurality of network paths is not to be trusted based at least on a property of the second network path; and
restricting, by the first device, a second session token of a second session for use over the plurality of network paths, responsive to determining that the second network path is not to be trusted.

3. The method of claim 1, further comprising:
identifying, by the first device, responsive to determining that a second network path of the plurality of network paths is not to be trusted, the session token validated for use over the plurality of network paths; and
restricting, by the first device, a second session token of the second network path for use over the plurality of network paths, responsive to identifying the session token.

4. The method of claim 1, further comprising:
determining, by the first device, responsive to determining that a second network path of the plurality of network paths is not to be trusted, that the plurality of network paths for which the session token is validated is inactive; and
restricting, by the first device responsive to determining that the plurality of network paths is inactive, a second session over the second network path for communications between the first device and the second device.

5. The method of claim 1, further comprising:
identifying, by the first device subsequent to validating the session token, the session token from an initiation of a second session between the first device and the second device via a second network path of the plurality of network paths; and
revalidating, by the first device without determination of whether the second network path is to be trusted, the session token for use in communications over the second network path.

6. The method of claim 1, further comprising:
validating, by the first device, a second session token identified from an initiation of a second session between the first device and a third device via a second network path based at least on a property of the second network path; and
providing, by the first device responsive to validating the second session token, the second session token to the first device and the third device for use in communications over a third network path between the second device and the third device.

7. The method of claim 1, further comprising:
determining, by the first device, that a second network path between the first device and a third device is not to be trusted based at least on a property of the second network path; and
restricting, by the first device responsive to determining that the second network path is not to be trusted, a second session token associated with a second session over the second network path from use in communications over a third network path between the second device and the third device.

8. The method of claim 1, further comprising:
causing, by the first device responsive to determining that a second network path between the first device and a third device is not to be trusted based on a property of the second network path, the third device to provide a second session token via a third network path between the second device and the third device; and
providing, by the first device responsive to determining that the third network path is to be trusted based at least on a property of the third network path, the second session token over the third network path to the third device for use in communications over the second network path and the third network path.

9. The method of claim 1, wherein determining that the network path is to be trusted further comprises identifying a network type of the network path as one of a plurality of trusted network types.

10. The method of claim 1, wherein determining that the network path is to be trusted further comprises determining that the second device is configured with a static address in the network path with at least one of a static routing or a reverse path filtering.

11. A system for validating a session token using a property, comprising:
a first device having one or more processors coupled with memory, configured to:
identify a session token from an initiation of a session between the first device and a second device via a network path of a plurality of network paths;
determine that the first network path is to be trusted based at least on a property of the network path;
validate the session token for use over the plurality of network paths, responsive to determining that the network path is to be trusted; and
provide, responsive to validating, the session token to the second device for use in communications over the plurality of network paths.

12. The system of claim 11, wherein the first device is further configured to:
determine that a second network path of the plurality of network paths is not to be trusted based at least on a property of the second network path; and
restrict a second session token of a second session for use over the plurality of network paths, responsive to determining that the second network path is not to be trusted.

13. The system of claim 11, wherein the first device is further configured to:
identify, responsive to determining that a second network path of the plurality of network paths is not to be trusted, the session token validated for use over the plurality of network paths; and
restrict a second session token of the second network path for use over the plurality of network paths, responsive to identifying the session token.

14. The system of claim 11, wherein the first device is further configured to:
determine, responsive to determining that a second network path of the plurality of network paths is not to be trusted, that the plurality of network paths for which the session token is validated is inactive; and
restrict, responsive to determining that the plurality of network paths is inactive, a second session over the second network path for communications between the first device and the second device.

15. The system of claim 11, wherein the first device is further configured to:
identify, subsequent to validating the session token, the session token from an initiation of a second session between the first device and the second device via a second network path of the plurality of network paths; and
re-validate, without determination of whether the second network path is to be trusted, the session token for use in communications over the second network path.

16. The system of claim 11, wherein the first device is further configured to:
validate a second session token identified from an initiation of a second session between the first device and a third device via a second network path based at least on a property of the second network path; and
provide, responsive to validating the second session token, the second session token to the first device and the third device for use in communications over a third network path between the second device and the third device.

17. The system of claim 11, wherein the first device is further configured to:
determine that a second network path between the first device and a third device is not to be trusted based at least on a property of the second network path; and
restrict, responsive to determining that the second network path is not to be trusted, a second session token associated with a second session over the second network path from use in communications over a third network path between the second device and the third device.

18. A non-transitory computer readable medium storing program instructions for causing one or more processors to:
identify a session token from an initiation of a session between a first device and a second device via a network path of a plurality of network paths;
determine that the first network path is to be trusted based at least on a property of the network path;
validate the session token for use over the plurality of network paths, responsive to determining that the network path is to be trusted; and
provide, responsive to validating, the session token to the second device for use in communications over the plurality of network paths.

19. The non-transitory computer readable medium of claim 18, wherein the program instructions further cause the one or more processors to:
determine that a second network path of the plurality of network paths is not to be trusted based at least on a property of the second network path; and
restrict a second session token of a second session for use over the plurality of network paths, responsive to determining that the second network path is not to be trusted.

20. The non-transitory computer readable medium of claim 18, wherein the program instructions further cause the one or more processors to:
identify, subsequent to validating the session token, the session token from an initiation of a second session between the first device and the second device via a second network path of the plurality of network paths; and
re-validate, without determination of whether the second network path is to be trusted, the session token for use in communications over the second network path.
